(19) United States
(12) Patent Application Publication
(10) Pub. No.: US 2012/0137553 A1
(43) Pub. Date: Jun. 7, 2012

(54) SCREEN SAFETY DEVICE

(76) Inventor: Barbara Ann Laustsen, Ocean, NJ (US)

(21) Appl. No.: 13/310,668

(22) Filed: Dec. 2, 2011

Related U.S. Application Data
(60) Provisional application No. 61/458,947, filed on Dec. 3, 2010.

(51) Int. Cl. G09F 7/04

(52) U.S. Cl. 40/600

(57) ABSTRACT

A screen decal prevents people and animals from walking into screen doors, windows and the like. The decal may include a first magnetic member and a second magnetic member. The first and second magnetically backed design panels may be installed on opposite sides of a screen and may be supported on the screen through magnetic attraction between the two panels through the screen. The first and second magnetically backed design panels may be the same or different in size and shape. Typically, the first and second magnetically backed design panels may be mirror images of each other. The decal may be applied and removed as needed from the screen.

### CROSS-REFERENCE TO RELATED APPLICATIONS

This application claims the benefit of priority of U.S. provisional patent application No. 61/458,947, filed Dec. 3, 2010, the contents of which are herein incorporated by reference.

### BACKGROUND OF THE INVENTION

The present invention relates to a screen safety device and, more particularly, to a screen saver having two magnetic decals that may be applied to each side of a screen to warn and subsequently prevent people or animals from attempting movement through the screen.

Picture windows often use stick on decals to prevent animals, such as birds, from flying into the window glass. Such decals, however can become unattractive, as the sticker may partially peel away from the glass. In some situations, the stickers may be removed completely removing the window glass protection.

Window and door screens may pose similar problems, as a screen's mesh may be small and may be designed to be nearly invisible. People and animals may walk through a screen, causing potentially damage, not only to the screen, but also to themselves.

As can be seen, there is a need for a device that may be applied to a screen to improve detection of the screen.

### SUMMARY OF THE INVENTION

In one aspect of the present invention, a panel assembly comprises a first magnetically backed design panel having a magnetic surface on at least one side thereof; a second magnetically back design panel having a magnetic surface on at least one side thereof; and a screen disposed between the first and second magnetically backed design panels.

In another aspect of the present invention, a method for preventing damage to a screen door or window comprises disposing a first magnetically backed design panel on a first side of the screen door or window; disposing a second magnetically backed design panel on a second, opposite side of the screen door or window; retaining the first and second magnetically backed design panels on the screen through a magnetic attraction therebetween; and positioning the first and second magnetically backed design panels in sight to prevent a person or animal from passing through the screen door or window.

In a further aspect of the present invention, a method for alerting a person or animal of the presence of a screen comprise disposing a first magnetically backed design panel on a first side of the screen door or window; disposing a second magnetically backed design panel on a second, opposite side of the screen door or window; retaining the first and second magnetically backed design panels on the screen through a magnetic attraction therebetween; and positioning the first and second magnetically backed design panels in sight to prevent a person or animal from passing through the screen door or window.

These and other features, aspects and advantages of the present invention will become better understood with reference to the following drawings, description and claims.

### BRIEF DESCRIPTION OF THE DRAWINGS

FIG. 1 is a close-up perspective view of a screen decal applied to a screen according to an exemplary embodiment of the present invention;

FIG. 2 is a perspective of the screen decal of FIG. 1;

FIG. 3 is a side view of the screen decal of FIG. 1 in use;

FIG. 4 is a side view of the screen decal of FIG. 1 applied to a screen;

FIG. 5 is a cross-sectional view taken along line 5-5 of FIG. 4;

FIG. 6 is an exploded view of the screen decal of FIG. 1;

FIG. 7 is front view of an exemplary screen decal;

FIG. 8 is a front view of a second embodiment of a screen decal;

FIG. 9 is a front view of a third embodiment of a screen decal;

FIG. 10 is a front view of a fourth embodiment of a screen decal; and

FIG. 11 is a front view of a fifth embodiment of a screen decal, showing both halves of the screen decal from a front view.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a screen decal to warn and subsequently prevent people and animals from walking or placing a body part into or through screen doors, windows and the like. The decal may include a first magnetic member and a second magnetic member. The first and second magnetically backed design panels may be installed on opposite sides of a screen and may be supported on the screen through magnetic attraction between the two panels through the screen. The first and second magnetically backed design panels may be the same or different in size and shape. Typically, the first and second magnetically backed design panels may be mirror images of each other. The decal may be applied and removed as needed from the screen.

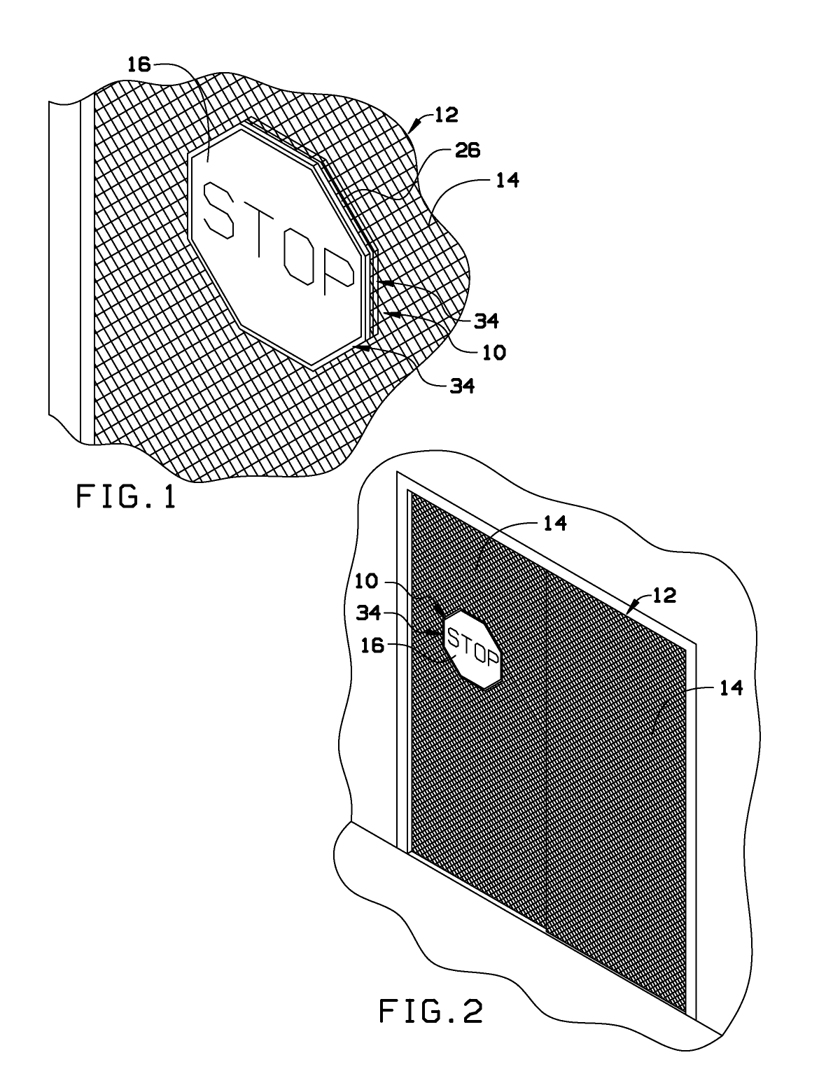

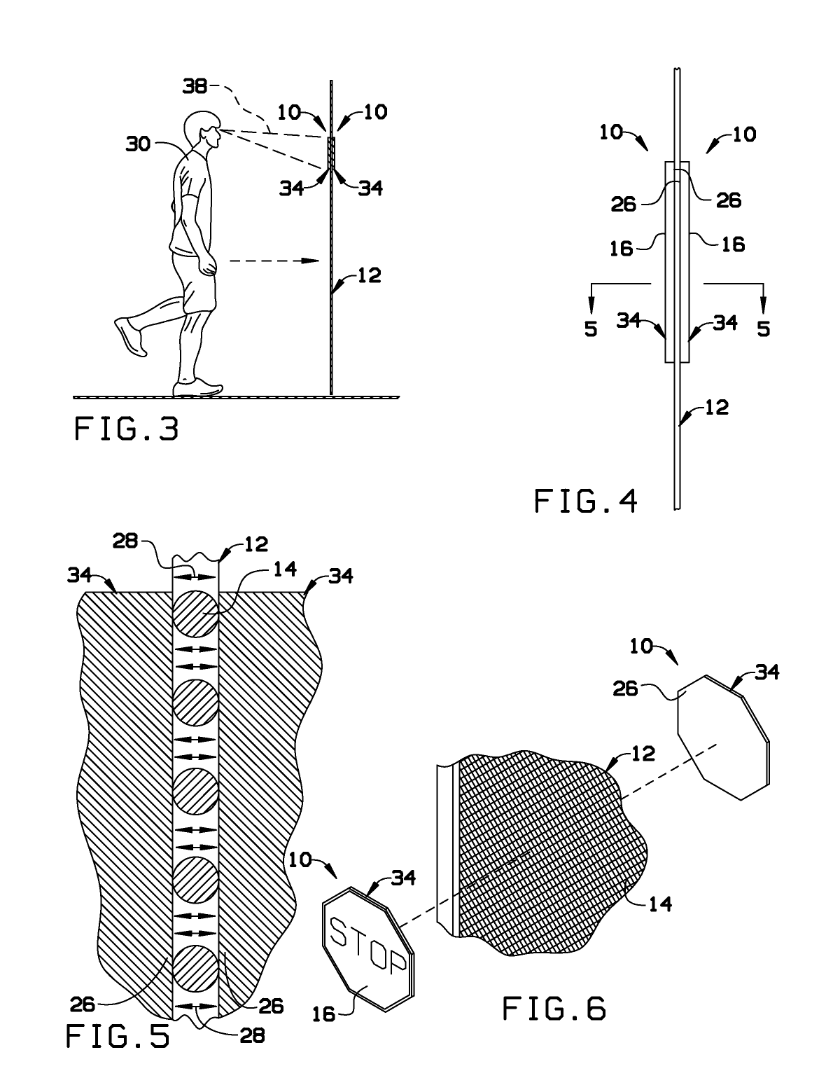

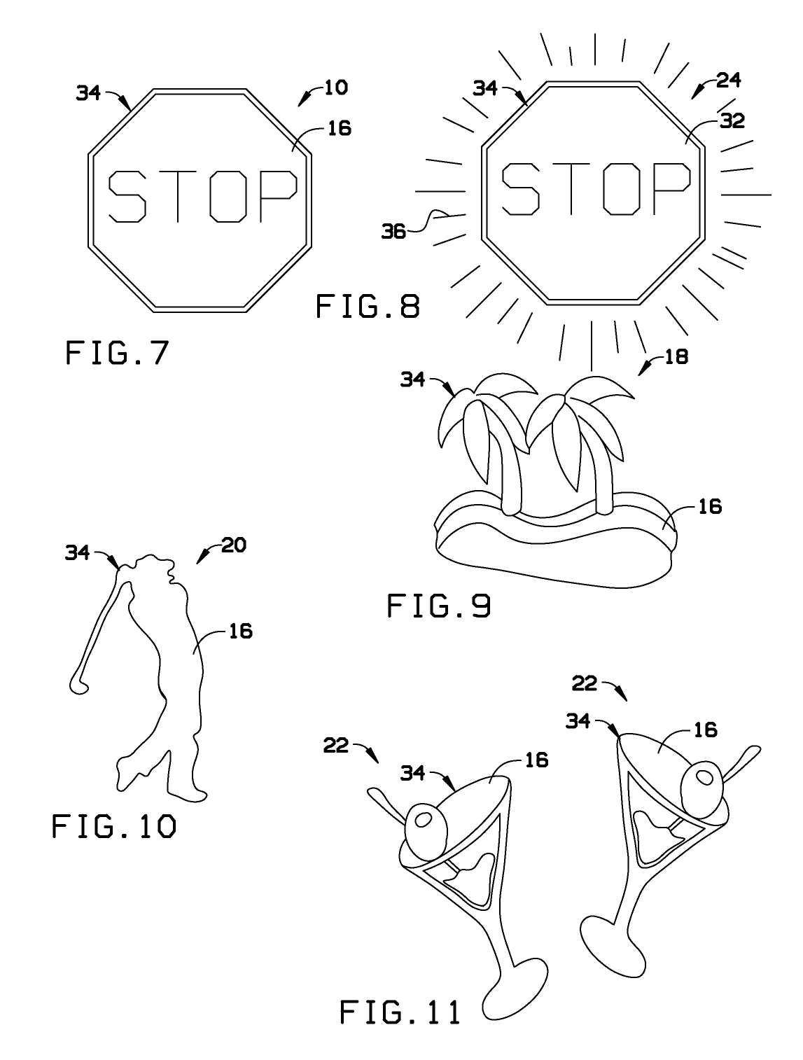

Referring now to FIGS. 1 through 6, an exemplary embodiment of a decal 10 may include first and second magnetically backed design panels 16 adapted to be attached to opposite sides of a screen 14 of a screen door or window 12. The first and second magnetically backed design panels 16 may combine on the screen 14 to form a panel assembly 34. The panel assembly 34 may be placed at various heights on the screen door or window 12. In some embodiments, as shown in FIG. 3, the panel assembly 34 may be placed at eye level on a screen door 12. In some embodiments, more than one panel assembly 34 may be disposed on a screen door or window 12, for example, one panel assembly 34 may be disposed at an adult's height, and one panel assembly 34 may be disposed at a child's/pet's height.

The magnetically backed design panels 16 may have a magnetic backing 26 on an entire back surface of the panel 16. For example, the panels 16 may be stamped out of sheets of magnetic material and stickers, paint, embossing, laser printing or the like, may be used to apply a design to the unmagnetized side for visual appeal. In some embodiments, the magnetic backing 26 may be disposed on only a portion of the back surface of the panel, for example, only about a perimeter of the back panel.

As shown in FIG. 5, when the magnetically backed design panels 16 are disposed on either side of the screen 14 to form the panel assembly 34, a magnetic force 28 may hold the panels 16 together on the screen 14.

As discussed above, the panels 16 may be made of the same size and shape. In some embodiments, each of the panels 16 may be mirror images of each other, as shown in FIG. 11. This configuration permits the two panels to align when placed on the screen 14 to form the panel assembly 34. In other embodiments, the panels 16 may be formed in different sizes and/or shapes. As shown in FIG. 8, a panel 32 may have a glow-in-the-dark or a self-illuminating face design. Light 36 may be emitted from such a panel 32. In some embodiments, the panel 32 may be powered by a power source, such as a battery, solar power or the like.

FIGS. 8 through 11 show various exemplary designs 18, 20, 22, 24 of the panel shape and size. While various exemplary embodiments of the invention are illustratively demonstrated with specific component sizes and designs, it should be understood that the invention contemplates various shapes, sizes and designs for the panels 16. Modifications in component configuration, design and usage may be made without departing from the spirit and scope of the present invention.

It should be understood, of course, that the foregoing relates to exemplary embodiments of the invention and that modifications may be made without departing from the spirit and scope of the invention as set forth in the following claims.

What is claimed is:

1. A panel assembly comprising:
a first magnetically backed design panel having a magnetic surface on at least one side thereof;
a second magnetically back design panel having a magnetic surface on at least one side thereof; and
a screen disposed between the first and second magnetically backed design panels.

2. The panel assembly of claim 1, wherein the first magnetically backed design panel is a mirror image of the second magnetically backed design panel.

3. The panel assembly of claim 1, wherein the panel assembly is disposed on the screen at eye level.

4. The panel assembly of claim 1, wherein the first magnetically backed design panel has the same design as the second magnetically back design panel.

5. A method for preventing damage to a screen door or window, the method comprising:
disposing a first magnetically backed design panel on a first side of the screen door or window;
disposing a second magnetically backed design panel on a second, opposite side of the screen door or window;
retaining the first and second magnetically backed design panels on the screen through a magnetic attraction therebetween; and
positioning the first and second magnetically backed design panels in sight to prevent a person or animal from passing through the screen door or window.

6. The method of claim 5, further comprising self-illuminating at least one of the first and second magnetically backed design panels.

7. The method of claim 5, wherein the first magnetically backed design panel has a first visual image that is the same as a second visual image on the second magnetically backed design panel.

8. A method for alerting a person or animal of the presence of a screen, the method comprising:
disposing a first magnetically backed design panel on a first side of the screen door or window;
disposing a second magnetically backed design panel on a second, opposite side of the screen door or window;
retaining the first and second magnetically backed design panels on the screen through a magnetic attraction therebetween; and
positioning the first and second magnetically backed design panels in sight to prevent a person or animal from passing through the screen door or window.

9. The method of claim 8, further comprising disposing a third and fourth magnetically backed design panel sandwiching the screen door or window at a location different from the first and second magnetically backed design panels.

10. The method of claim 9, further comprising self-illuminating at least one of the first and second magnetically backed design panels.
